(19) United States
(12) Patent Application Publication
(10) Pub. No.: US 2011/0055750 A1
(43) Pub. Date: Mar. 3, 2011

(54) SMALL-SIZED SETTLEMENT TERMINAL AND CONTROLLING METHOD FOR THE SAME

(75) Inventors: Junpei Fukuda, Shizuoka (JP); Yasutsugu Sasaki, Kanagawa (JP)

(73) Assignee: TOSHIBA TEC KABUSHIKI KAISHA, Tokyo (JP)

(21) Appl. No.: 12/859,518

(22) Filed: Aug. 19, 2010

(30) Foreign Application Priority Data
Aug. 25, 2009 (JP) 2009-194680

(51) Int. Cl. G06F 3/041; G06F 3/048

(52) U.S. Cl. 715/773; 345/173

(57) ABSTRACT

According to one embodiment, an information display area, a set key display area, and an information input area having a greater area than any of the information display area and the set key display area is set in a display zone of a display section. A ten-key image pattern for inputting amount information about settlement is displayed in the information input area.

### CROSS-REFERENCE TO RELATED APPLICATIONS

This application is based upon and claims the benefit of priority from Japanese Patent Application No. 2009-194680, filed on Aug. 25, 2009, the entire contents of which are incorporated herein by reference.

### FIELD

Embodiments described herein relate generally to a small-sized settlement terminal and a controlling method for the same.

### BACKGROUND

A settlement terminal used for sales of articles has a display section, an operation section, a card reader and the like.

An operator in a store inputs a sales price by key operation in the operation section, designates the type of a card for payment presented by a customer, by key operation in the operation section, and selects a payment condition for the designated card by key operation in the operation section.

A smaller size and good operability are demanded of such a settlement terminal.

### BRIEF DESCRIPTION OF THE DRAWINGS

FIG. 1 is a perspective view showing the appearance of the body according to an embodiment.

FIG. 2 is a block diagram showing a control circuit according to the embodiment.

FIG. 3 shows a display content in a display section according to the embodiment.

### DETAILED DESCRIPTION

In general, according to one embodiment, a settlement terminal includes:

a touch panel-type display section; and

a display control section which sets an information display area to display amount information about settlement, a set key display area to display a set key for finalizing an operation, and an information input area having a greater area than any of the information display area and the set key display area, in a display zone of the display section, and displays a ten-key image pattern for inputting the amount information about settlement in the information input area.

Hereinafter, an embodiment of the invention will be described with reference to the drawings.

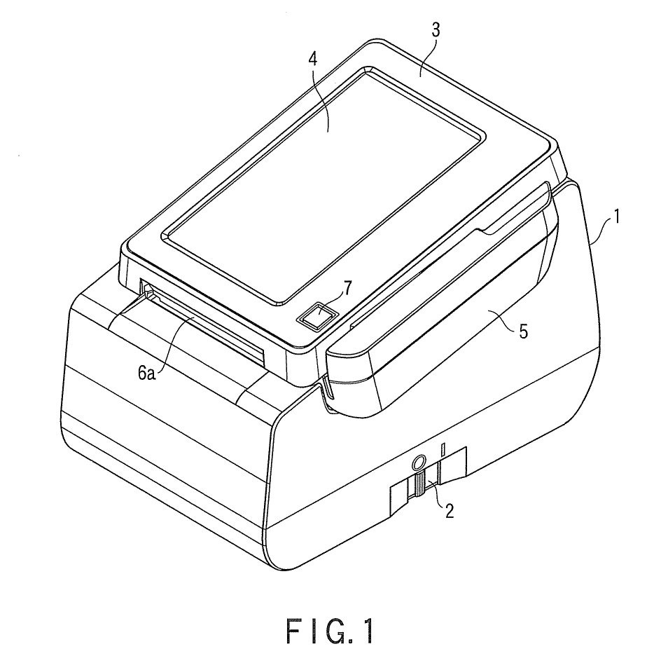

In FIG. 1, numeral 1 represents the body of a small-sized settlement terminal. This body 1 is installed on a checkout counter or the like in a store together with a POS terminal or an electronic register. The body 1 also has a power switch 2 in a lateral part and a top unit 3 which can freely open and close. The top unit 3 has a rectangular touch panel-type display section 4 on the top side, a card reader 5 in a lateral part, a paper discharge port 6a of a printer 6 which will be described later, on a bottom edge, and a reset button 7 at a position beside the display section 4 on the top side.

As a card for settlement presented by a customer, for example, a credit card or a debit card, is inserted and slid in the card reader 5, the card reader 5 reads data recorded on the card. The printer 6 exists within the body 1 or within the top unit 3. The printer 6 prints settlement information based on a touch operation in the display section 4 and the information read by the card reader 5 on a rolled sheet housed in the body 1, then cuts the printed rolled sheet as a receipt, and discharges the receipt from the paper discharge port 6a. The reset button 7 is to clear the input information in the display section 4 and the information read by the card reader 5.

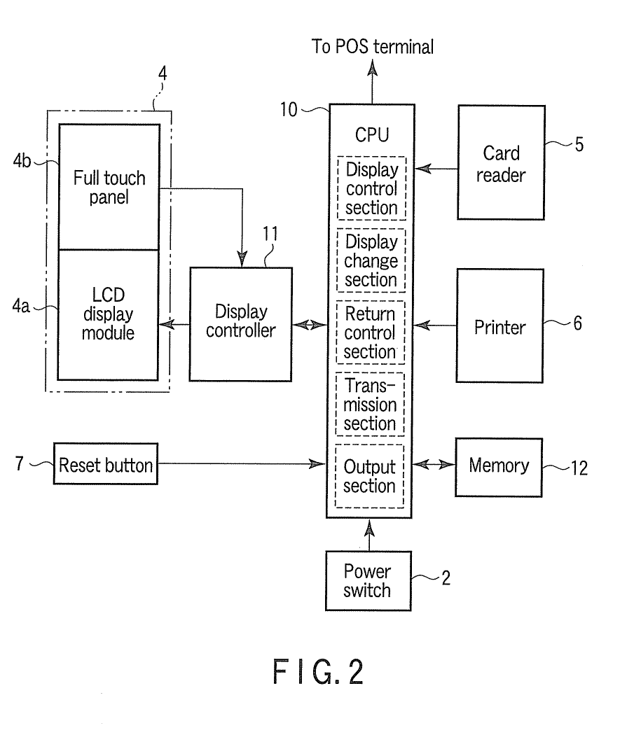

FIG. 2 shows a control circuit in the body 1 and the top unit 3.

The display section 4 has an LCD display module 4a which can display a color image and a full touch panel 4b arranged on the LCD display module 4a, and functions as a graphical user interface (GUI).

The power switch 2, the card reader 5, the printer 6, the reset button 7, a display controller 11, and a memory 12 are connected to a CPU 10 of a microcomputer which functions as a main control unit.

The display controller 11 causes the LCD display module 4a in the display section 4 to display various operation screens generated by the CPU 10. Also, when the full touch panel 4b in the display section 4 is touched, the display controller 11 supplies the display content on the LCD display module 4a corresponding to the touch position to the CPU 10 as input information.

The memory 12 stores a control program which is necessary for the control of the CPU 10, various kinds of image pattern information to generate the various operation screens, and coordinate information to designate a display zone for the image pattern information on the LCD display module 4a, or the like.

The CPU 10 has the following sections (1) to (5) as its main functions.

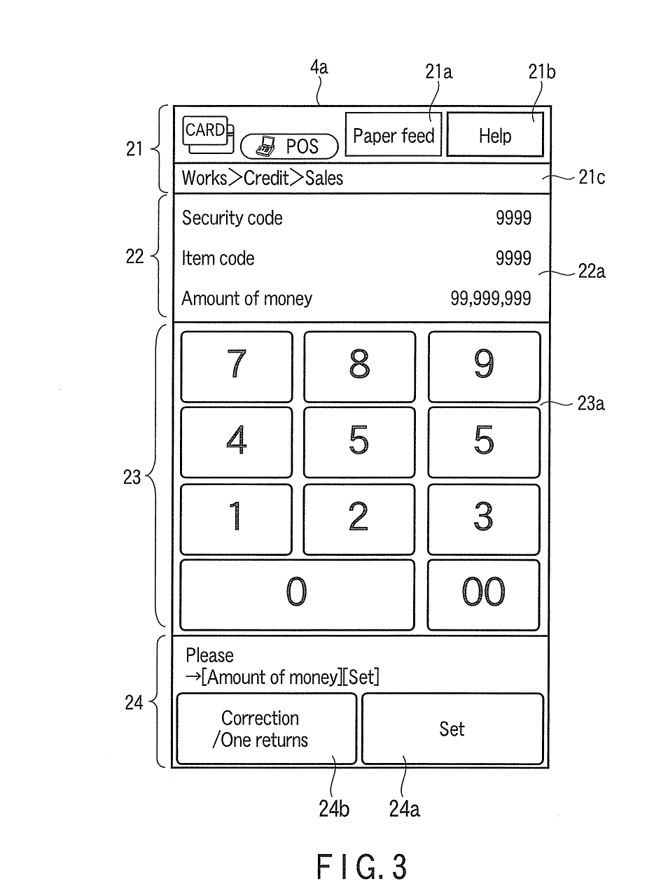

(1) A display control section which sets a first information display area 21, a second information display area 22, an information input area 23 and a set key display area 24 in order in the direction orthogonal to the direction of the width of the display zone of the LCD display module 4a in the display section 4, as shown in FIG. 3. The display control section displays a paper feed key image pattern 21a, a help key image pattern 21b, and function information 21c or the like about the small-sized settlement terminal, in the first information display area 21 situated at the top position. The display control section displays numeric information 22a including security code, item code, the amount of money or the like, in the second information display area 22 situated at the second position from the top. The display control section displays a ten-key image pattern 23a including large image patterns of plural numeric keys “0”, “00”, “1”, “2”, . . . “9” in the information input area 23 situated at the center. The display control section displays a set key image pattern 24a and a correction key image pattern 24b or the like in the set key display area 24 situated at the bottom position. Moreover, the display control section displays amount information inputted by a touch on the ten-key image pattern 23a in the information input area 23, in the second information display area 22. Specifically, when a touch is released from the ten-key image pattern 23a displayed in the information input area 23, the numeric information of the numeric key that is touched up to this point is inputted and amount information based on the input is displayed in the second information display area 22.

(2) A display change section which, when the display section 4 is touched, changes the display of the image pattern situated at the touch position, of the image patterns displayed in the display section 4, to the display of the image pattern having a different display form. Specifically, the color of the display of the touched image pattern is changed from a color of the display of the image pattern that indicates a non-touched state, to a color of the display of the image pattern that indicates a touched state.

(3) A return control section which, when a touch is released from the display section 4, returns the display form of the image pattern situated at the touch position up to this point, to the original display form. Specifically, the color of the display of the image pattern from which a touch is released is returned from the color of the display of the image pattern that indicates the touched state to the color of the display of the image pattern that indicates the non-touched state.

(4) A transmission section which, when the set key image pattern 24a in the display in the set key display area 24 is touched, finalizes the amount information displayed in the information display area 22 and transmits the finalized amount information to the POS terminal, which is on a higher order, together with the information read by the card reader 5.

(5) An output section which receives information of settlement executed by the POS terminal on the basis of the transmitted amount information and the read information, from the POS terminal, and causes the printer 6 to output a print of the received information.

The information input area 23 has the following characteristics (11) to (15).

(11) The information input area 23 has a greater area than any other area, that is, any of the first information display area 21, the second information display area 22, and the set key display area 24.

(12) The area of the information input area 23 is greater than the total area of the first information display area 21 and the second information display area 22.

(13) The area of the information input area 23 is greater than the total area of the first information display area 21 and the set key display area 24.

(14) The area of the information input area 23 is greater than the total area of the second information display area 22 and the set key display area 24.

(15) The length of the information input area 23 in the direction orthogonal to the direction of the width of the display zone of the LCD display module 4a is longer than the length of any of the first information display area 21, the second information display area 22, and the set key display area 24.

Next, the operation will be described.

When the power switch 2 is turned on, the CPU 10 generates the ten-key operation screen shown in FIG. 3 as an operation screen that is necessary for settlement of article sales, on the basis of image pattern information and coordinate information in the memory 12, and displays the generated ten-key operation screen on the full touch panel 4b in the display section 4 (ACT 101).

The ten-key operation screen has the first information display area 21, the second information display area 22, the information input area 23 and the set key display area 24 in order in the direction orthogonal to the direction of the width of the display zone of the LCD display module 4a.

The first information display area 21 situated at the top position includes the display of the paper feed key image pattern 21a, the help key image pattern 21b, and the function information 21c about the small-sized settlement terminal. The second information display area 22 situated at the second position from the top includes the display of the numeric information 22a including security code, item code, the amount of money or the like. The large information input area 23 situated at the center includes the display of the ten-key image pattern 23a including the large image patterns of the plural numeric keys “0”, “00”, “1”, “2”, . . . “9”, to the full extent of the area. The set key display area 24 situated at the bottom position includes the display of the set key image pattern 24a and the correction key image pattern 24b or the like.

When an article which a customer wants to purchase is brought to the checkout counter, the operator in the store inputs the amount of sales by touching, with fingers, various numeric keys of the ten-key image pattern 23a displayed in the display section 4, and then inserts a credit card or debit card presented by the customer into the card reader 5 to read the card. As the input of the amount information, the reading of the card information, and the input of a payment condition are carried out, the settlement of article sales on the POS terminal side is completed. The CPU 10 discharges a receipt on which the content of the settlement is printed, from the paper discharge port 6a of the top unit 3.

When the operator touches the ten-key image pattern 23a, the operator in the store finds it easy to see and operate each of the numeric keys “0”, “00”, “1”, “2”, . . . “9” since the ten-key image pattern 23a is displayed in a large size at the center of the display zone of the display section 4.

The image pattern display of the touched numeric key, of the numeric keys in the ten-key image pattern 23a, changes from the display in the color indicating the non-touched state to the display in a different color indicating the touched state. When the touch is released from the numeric key, the display of the image pattern of the numeric key returns from the display in the color indicating the touched state to the display in the color indicating the non-touched state. With this change in color, together with the large display of each numeric key that is easy to see, it is possible to accurately understand which numeric key is touched and which numeric key a touch is released from.

In this manner, the information input area 23 having a large area is displayed in the display section 4 and the ten-key image pattern 23a including the large image patterns of the plural numeric keys “0”, “00”, “1”, “2”, . . . “9” is displayed to the full extent of the information input area 23. Thus, good operability can be secured. That is, despite the small size of the settlement terminal, it is possible to carry out easy input operations without mistakes and its operability significantly improves. The improvement in operability is highly advantageous to the operator or so-called cashier who is busy moving around in the store, since the operation efficiency can be improved.

In the above embodiment, the ten-key image pattern 23a is displayed at the center of the display zone of the display section 4. However, the position of the ten-key image pattern 23a can be properly selected in consideration of the size and the state of use of the first information display area 21, the second information display area 22 and the set key display area 24.

When a touch on the display section 4 corresponds to an image pattern for operation, the display of the image pattern situated at the touch position is immediately changed to the display of the image pattern in a different display form. Therefore, it is possible to notify the operator easily and accurately whether the touch position is appropriate or not.

If the touch position does not correspond to a desired image pattern or the touch operation itself is to be suspended, the touch position can simply be slid and removed from the image pattern. Thus, the display of the image pattern returns from the display of the image pattern in the color indicating the touched state to the display of the image pattern in the color indicating the non-touched state. Therefore, quick re-operation can be carried out without mistakes while any erroneous input of information can be prevented. Thus, good operability can be secured.

In the above embodiment, the change in color is described as an example of the change in display form. However, the luminance of the display may be changed or the brightness of the display may be changed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A small-sized settlement terminal comprising:
a touch panel-type display section; and
a display control section which sets an information display area to display amount information about settlement, a set key display area to display a set key for finalizing an operation, and an information input area having a greater area than any of the information display area and the set key display area, in a display zone of the display section, and displays a ten-key image pattern for inputting the amount information about settlement in the information input area.

2. The terminal of claim 1, wherein the area of the information input area is greater than a total area of the information display area and the set key display area.

3. The terminal of claim 1, wherein the information input area has a length in a direction orthogonal to a direction of width of the display zone of the display section, the length being greater than any of lengths of the information display area and the set key display area.

4. The terminal of claim 1, wherein the display control section sets an information display area to display amount information about settlement, a set key display area to display a set key for finalizing an operation, and an information input area having a greater area than any of the information display area and the set key display area, in a display zone of the display section, and displays a ten-key image pattern for inputting the amount information about settlement in the information input area and displays amount information inputted by a touch on the ten-key image pattern, in the information display area.

5. The terminal of claim 1, wherein the display control section sets a first information display area to display at least function information about a function Of the terminal, a second information display area to display amount information about settlement, a set key display area to display a set key for finalizing an operation, and an information input area having a greater area than any of the first information display area, the second information display area and the set key display area, in a display zone of the display section, and displays a ten-key image pattern for inputting the amount information about settlement in the information input area.

6. The terminal of claim 5, wherein the area of the information input area is greater than a total area of the first information display area and the second information display area.

7. The terminal of claim 5, wherein the area of the information input area is greater than a total area of the first information display area and the set key display area.

8. The terminal of claim 5, wherein the area of the information input area is greater than a total area of the second information display area and the set key display area.

9. The terminal of claim 5, wherein the information input area has a length in a direction orthogonal to a direction of width of the display zone of the display section, the length being greater than any of lengths of the first information display area, the second information display area and the set key display area.

10. A small-sized settlement terminal comprising:
a touch panel-type display section; and
a display control section which sets an information display area to display amount information about settlement, a set key display area to display a set key for finalizing an operation, and an information input area situated between the information display area and the set key display area, in a display zone of the display section, and displays a ten-key image pattern for inputting the amount information about settlement in the information input area.

11. The terminal of claim 10, wherein the area of the information input area is greater than a total area of the information display area and the set key display area.

12. The terminal of claim 10, wherein the information input area has a length in a direction orthogonal to a direction of width of the display zone of the display section, the length being greater than any of lengths of the information display area and the set key display area.

13. The terminal of claim 10, wherein the display control section sets an information display area to display amount information about settlement, a set key display area to display a set key for finalizing an operation, and an information input area situated between the information display area and the set key display area, in a display zone of the display section, and displays a ten-key image pattern for inputting the amount information about settlement in the information input area and displays amount information inputted by a touch on the ten-key image pattern, in the information display area.

14. The terminal of claim 10, wherein the display control section sets a first information display area to display at least function information about a function of the terminal, a second information display area to display amount information about settlement, a set key display area to display a set key for finalizing an operation, and an information input area situated between the second information display area and the set key display area, in a display zone of the display section, and displays a ten-key image pattern for inputting the amount information about settlement in the information input area.

15. The terminal of claim 14, wherein the area of the information input area is greater than a total area of the first information display area and the second information display area.

16. The terminal of claim 14, wherein the area of the information input area is greater than a total area of the first information display area and the set key display area.

17. The terminal of claim 14, wherein the area of the information input area is greater than a total area of the second information display area and the set key display area.

18. The terminal of claim 14, wherein the information input area has a length in a direction orthogonal to a direction of width of the display zone of the display section, the length being greater than any of lengths of the first information display area, the second information display area and the set key display area.

19. A controlling method for a small-sized settlement terminal including a touch panel-type display section, the method comprising:
setting an information display area to display amount information about settlement, a set key display area to display a set key for finalizing an operation, and an information input area having a greater area than any of the information display area and the set key display area, in a display zone of the display section; and
displaying a ten-key image pattern for inputting the amount information about settlement in the information input area.
